(19) United States
(12) Patent Application Publication
(10) Pub. No.: US 2023/0137535 A1
(43) Pub. Date: May 4, 2023

(54) COMPOSITION COMPRISING MULTIPLE BACULOVIRUSES TO TARGET DIFFICULT INSECT SPECIES

(71) Applicant: Bayer Aktiengesellschaft, Leverkusen (DE)

(72) Inventors: Julia ULRICH, Düsseldorf (DE); Matthew TARVER, St. Louis, MO (US); Nigel Peter GODLEY, Pulheim (DE); Donglan TIAN, Davis, CA (US); Bill HENDRIX, Köln (DE); Reed Nathan ROYALTY, Davis, CA (US)

(21) Appl. No.: 17/911,640

(22) PCT Filed: Mar. 19, 2021
(86) PCT No.: PCT/EP2021/057113

§ 371 Date: Sep. 14, 2022

Related U.S. Application Data
(60) Provisional application No. 62/992,781, filed on Mar. 20, 2020.

(30) Foreign Application Priority Data
Apr. 3, 2020 (EP) 20167948.7

(51) Int. Cl. A01N 63/40; A01P 7/04

(52) U.S. Cl. CPC A01N 63/40; A01P 7/04

(57) ABSTRACT

The present invention relates to an agricultural composition comprising at least three insect pathogenic viruses, selected from Autographica californica (Alfalfa Looper) multiple nucleopolyhedrovirus (AcMNPV), Helicoverpa armigera nucleopolyhedrosis virus (HaNPV), Plutella xylostella granulovirus (PxGV), Spodoptera litura (oriental leafworm moth) nucleopolyhedrovirus (SpltNPV) and Spodoptera exigua (beet armyworm) nucleopolyhedrovirus (SeNPV).

The use of plant protection products comprising biological control agents (BCAs) has become a valuable alternative in the field of plant protection. Multiple biological control agents directed against fungi or insects as well as those promoting plant health have been put on the market.

Several plant protection agents based on bacteria, fungi or plant extracts are known today. Also, baculoviruses have been used to combat plant pests. In most cases, the efficacy of BCAs is not at the same level as for conventional insecticides and fungicides, especially in case of severe infection pressure. Consequently, in some circumstances, biological control agents are, in particular in low application rates, not entirely satisfactory. Thus, there is a constant need for developing new plant protection compositions, including biological control agents, to strive to fulfill the above-mentioned requirements.

Baculoviruses are known to be largely species-specific so that only a narrow target range is affected by a single baculovirus. Against certain insect species, however, it is still desirable to develop biological control agents that are more efficient than existing ones while having all advantages of those biological control agents known to date and advantageously also a better efficacy.

In view of this, it was, inter alia, an object of the present invention to provide compositions which exhibit enhanced activity against certain insect pests as compared to existing biological control agents. Furthermore, it was an object to provide efficient biological solutions against insect pests which are otherwise difficult to target using biological plant protection.

Accordingly, in one aspect, the present invention relates to an agricultural composition comprising at least three insect pathogenic viruses, selected from Autographica californica (Alfalfa Looper) multiple nucleopolyhedrovirus (AcMNPV), Helicoverpa armigera nucleopolyhedrosis virus (HaNPV), Plutella xylostella granulovirus (PxGV), Spodoptera litura (cutworm or leafworm moth) nucleopolyhedrovirus (SpltNPV) and Spodoptera exigua (beet armyworm) nucleopolyhedrovirus (SeNPV).

Baculoviruses are viruses that specifically infect insects, mainly members of the orders Lepidoptera, Hymenoptera and Diptera. The Baculoviridae family is characterized by the fact that its members contain a circular, double-stranded DNA genome. The family comprises four genera, classified according to their structural, molecular and biological characteristics: alphabaculovirus (lepidopteran-specific nucleopolyhedroviruses [NPVs]), beta baculovirus (lepidopteran-specific granuloviruses [GVs]), deltabaculovirus (dipteran-specific nucleopolyhedroviruses), and gammabaculovirus (hymenopteran-specific nucleopolyhedroviruses). Of these genera, the most important ones for the purpose of the present invention are certain members of the two genera: nucleopolyhedroviruses (NPVs) and granuloviruses (GVs).

In the course of the present invention, it has surprisingly been found that a composition comprising at least three insect pathogenic viruses out of a group of specific viruses exert remarkable properties against target and non-target pests. It has consistently been observed that viruses which target a different species, when used in combination with another virus targeting a different species, enhance the efficacy of that latter virus. All in all, the efficacy of a composition comprising at least three different viruses of which only one was targeting the tested insect species was greatly enhanced.

Another remarkable effect of a composition of the invention was that a species which is not targeted by any of the viruses used could be efficiently combatted using a combination of at least three viruses as disclosed herein.

Basically, any combination of three viruses out of the above five viruses may be chosen. These include the following combinations:

AcMNPV, HaNPV and PxGV

AcMNPV, HaNPV and SeNPV

AcMNPV, HaNPV and SpltNPV

AcMNPV, PxGV and SeNPV

AcMNPV, PxGV and SpltNPV

AcMNPV, SpltNPV and SeNPV

HaNPV, PxGV and SeNPV

HaNPV, PxGV and SpltNPV

PxGV, SeNPV and SpltNPV

In a preferred embodiment, the at least three insect pathogenic viruses are AcMNPV, HaNPV and PxGV. As can be seen in the examples of the present application, this combination showed excellent efficacy against Spodoptera exigua see Examples 6 and 10).

In another preferred embodiment, the at least three insect pathogenic viruses are SeNPV, SpltNPV und PxGV.

In yet another preferred embodiment, the at least three insect pathogenic viruses are SeNPV, HaNPV and PxGV.

In a preferred embodiment, the insect pathogenic viruses are comprised in the agricultural composition in a ratio of between 10:1:1 and 1:1:10, preferably between 5:1:1 and 1:1:5.

In a more preferred embodiment, the insect pathogenic viruses are comprised in the agricultural composition in a ratio of 1:1:1.

In one preferred embodiment, the agricultural composition comprises at least one further insect pathogenic virus.

Generally, any insect pathogenic virus may be added to the composition in connection with the present invention.

In a preferred embodiment, the agricultural composition comprises at least one further insect pathogenic virus selected from the group consisting of Spodoptera litura (oriental leafworm moth) nucleopolyhedrovirus (SpltNPV) and Spodoptera exigua (beet armyworm) nucleopolyhedrovirus (SeNPV). This especially relates to compositions where already AcMNPV, HaNPV and PxGV are present.

For compositions where SeNPV, SpltNPV und PxGV are present, additional beneficial viruses comprise AcMNPV and HaNPV.

In a more preferred embodiment, the agricultural composition comprises at least four insect pathogenic viruses.

In a more preferred embodiment, the composition comprises AcMNPV, HaNPV, PxGV and SpltNPV.

In another more preferred embodiment, the composition comprises AcMNPV, HaNPV, PxGV and SeNPV.

Other preferred compositions comprising four baculoviruses include the following ones:

AcMNPV, PxGV, SeNPV and SpltNPV,

AcMNPV, HaNPV, SeNPV and SpltNPV, and

HaNPV, PxGV, SeNPV and SpltNPV.

Most preferably, the composition comprises all five viruses AcMNPV, HaNPV, PxGV, SpltNPV and SeNPV.

As can be seen in the examples, excellent control of Tuta absoluta, Spodoptera frugiperda, Helicoverpa armigera and Spodoptera exigua could be shown using five different insect pathogenic viruses. Most notably, the non-target species Tuta absoluta could be effectively controlled already 4 days after treatment.

The present invention is particularly useful also as an alternative to other biological control agents. For example, in the examples comparisons were made between the compositions of the present invention and Bacillus thuringiensis bacteria but also with chemical standards.

In an agricultural composition of the present invention each insect pathogenic virus may be present in an amount of between 1×10⁴ and 1×10¹² occlusion bodies per ml or gram preferably, between 1×10⁸ and 1×10¹² occlusion bodies per mL or gram.

The agricultural composition according to the invention comprises certain insect pathogenic viruses. It is to be understood that different isolates having a slightly different genotype exist for each baculovirus. In connection with the present invention, any isolates of an insect pathogenic virus may be used. Exemplary isolates are selected from AcMNPV isolates comprised in VPN-ULTRA® from Agricola El Sol, LOOPEX from Andermatt Biocontrol, LEPIGEN from AgBiTech and isolate C6, HaNPV isolates comprises in VIVUS® MAX and ARMIGEN from AgBiTech, HELICOVEX from Andermatt Biocontrol and Keyun HaNPV, PxGV isolates comprised in PLUTELLAVEX® (Keyun) and isolate K1, SpltNPV isolate K1 and SeNPV isolates comprised in KEYUN SeNPV.

In one preferred embodiment, at least one insect pathogenic virus in the composition according to the invention is a recombinant virus. Recombinant insect pathogenic viruses may be created by exchanging one or more genetic elements in the virus genome, e.g., in order to widen the spectrum of target pests.

The agricultural compositions of the invention are effective for use in the biological control of insects from orders Hymenoptera, Diptera and Lepidoptera.

Arthropod species which may be targeted by the composition according to the invention include crop pest species of the Lepidoptera, pest species of the Diptera, and pest species of the Coleoptera such as of the Scarabaeidae. The insect pests that may be targeted using the composition according to the invention are typically members of the Lepidoptera and include the larvae of Lepidoptera species that infest food processing and food storage sites.

Lepidopteran species include Achroia grisella, Acronicta major, Adoxophyes spp., for example Adoxophyes orana, Aedia leucomelas, Agrotis spp., for example Agrotis segetum, Agrotis ipsilon, Alabama spp., for example Alabama argillacea, Amyelois transitella, Anarsia spp., Anticarsia spp., for example Anticarsia gemmatalis, Argyroploce spp., Autographa spp., Barathra brassicae, Blastodacna atra, Borbo cinnara, Bucculatrix thurberiella, Bupalus piniarius, Busseola spp., Cacoecia spp., Caloptilia theivora, Capua reticulana, Carpocapsa pomonella, Carposina niponensis, Cheimatobia brumata, Chilo spp., for example Chilo plejadellus, Chilo suppressalis, Choreutis pariana, Choristoneura spp., Chrysodeixis chalcites, Clysia ambiguella, Cnaphalocerus spp., Cnaphalocrocis medinalis, Cnephasia spp., Conopomorpha spp., Conotrachelus spp., Copitarsia spp., Cydia spp., for example Cydia nigricana, Cydia pomonella, Dalaca noctuides, Diaphania spp., Diparopsis spp., Diatraea saccharalis, Dioryctria spp., for example Dioryctria zimmermani, Earias spp., Ecdytolopha aurantium, Elasmopalpus lignosellus, Eldana saccharina, Ephestia spp., for example Ephestia elutella, Ephestia kuehniella, Epinotia spp., Epiphycan postvittana, Erannis spp., Erschoviella musculana, Etiella spp., Eudocima spp., Eulia spp., Eupoecilia ambiguella, Euproctis spp., for example Euproctis chrysorrhoea, Euxoa spp., Feltia spp., Galleria mellonella, Gracillaria spp., Grapholitha spp., for example Grapholita molesta, Grapholita prunivora, Hedylepta spp., Helicoverpa spp., for example Helicoverpa armigera, Helicoverpa zea, Heliothis spp., for example Heliothis virescens, Hepialus spp., for example Hepialus humuli, Hofmannophila pseudospretella, Homoeosoma spp., Homona spp., Hyponomeuta padella, Kakivoria flavofasciata, Lampides spp., Laphygma spp., Laspeyresia molesta, Leucinodes orbonalis, Leucoptera spp., for example Leucoptera coffeella, Lithocolletis spp., for example Lithocolletis blancardella, Lithophane antennata, Lobesia spp., for example Lobesia botrana, Loxagrotis albicosta, Lymantria spp., for example Lymantria dispar, Lyonetia spp., for example Lyonetia clerkella, Malacosoma neustria, Maruca testulalis, Mamestra brassicae, Melanitis leda, Mocis spp., Monopis obviella, Mythimna separata, Nemapogon cloacellus, Nymphula spp., Oiketicus spp., Omphisa spp., Operophtera spp., Oria spp., Orthaga spp., Ostrinia spp., for example Ostrinia nubilalis, Panolis flammea, Parnara spp., Pectinophora spp., for example Pectinophora gossypiella, Perileucoptera spp., Phthorimaea spp., for example Phthorimaea operculella, Phyllocnistis citrella, Phyllonorycter spp., for example Phyllonorycter blancardella, Phyllonorycter crataegella, Pieris spp., for example Pieris rapae, Platynota stultana, Plodia interpunctella, Plusia spp., Plutella xylostella (=Plutella maculipennis), Podesia spp., for example Podesia syringae, Prays spp., Prodenia spp., Protoparce spp., Pseudaletia spp., for example Pseudaletia unipuncta, Pseudoplusia includens, Pyrausta nubilalis, Rachiplusia nu, Schoenobius spp., for example Schoenobius bipunctifer, Scirpophaga spp., for example Scirpophaga innotata, Scotia segetum, Sesamia spp., for example Sesamia inferens, Sparganothis spp., Spodoptera spp., for example Spodoptera eradiana, Spodoptera exigua, Spodoptera frugiperda, Spodoptera praefica, Stathmopoda spp., Stenoma spp., Stomopteryx subsecivella, Synanthedon spp., Tecia solanivora, Thaumetopoea spp., Thermesia gemmatalis, Tinea cloacella, Tinea pellionella, Tineola bisselliella, Tortrix spp., Trichophaga tapetzella, Trichoplusia spp., for example Trichoplusia ni, Tryporyza incertulas, Tuta absoluta and Virachola spp.

Dipteran species include Aedes spp., for example Aedes aegypti, Aedes albopictus, Aedes sticticus, Aedes vexans, Agromyza spp., for example Agromyza frontella, Agromyza parvicornis, Anastrepha spp., Anopheles spp., for example Anopheles quadrimaculatus, Anopheles gambiae, Asphondylia spp., Bactrocera spp., for example Bactrocera cucurbitae, Bactrocera dorsalis, Bactrocera oleae, Bibio hortulanus, Calliphora erythrocephala, Calliphora vicina, Ceratitis capitata, Chironomus spp., Chrysomya spp., Chrysops spp., Chrysozona pluvialis, Cochliomya spp., Contarinia spp., for example Contarinia johnsoni, Contarinia nasturtii, Contarinia pyrivora, Contarinia schulzi, Contarinia sorghicola, Contarinia tritici, Cordylobia anthropophaga, Cricotopus sylvestris, Culex spp., for example Culex pipiens, Culex quinquefasciatus, Culicoides spp., Culiseta spp., Cuterebra spp., Dacus oleae, Dasineura spp., for example Dasineura brassicae, Delia spp., for example Delia antiqua, Delia coarctata, Delia florilega, Delia platura, Delia radicum, Dermatobia hominis, Drosophila spp., for example Drosphila melanogaster, Drosophila suzukii, Echinocnemus spp., Euleia heraclei, Fannia spp., Gasterophilus spp., Glossina spp., Haematopota spp., Hydrellia spp., Hydrellia griseola, Hylemya spp., Hippobosca spp., Hypoderma spp., Liriomyza spp., for example Liriomyza brassicae, Liriomyza huidobrensis, Liriomyza sativae, Lucilia spp., for example Lucilia cuprina, Lutzomyia spp., Mansonia spp., Musca spp., for example Musca domestica, Musca domestica vicina, Oestrus spp., Oscinella frit, Paratanytarsus spp., Paralauterborniella subcincta, Pegomya or Pegomyia spp., for example Pegomya betae, Pegomya hyoscyami, Pegomya rubivora, Phlebotomus spp., Phorbia spp., Phormia spp., Piophila casei, Platyparea poeciloptera, Prodiplosis spp., Psila rosae, Rhagoletis spp., for example Rhagoletis cingulata, Rhagoletis completa, Rhagoletis fausta, Rhagoletis indifferens, Rhagoletis mendax, Rhagoletis pomonella, Sarcophaga spp., Simulium spp., for example Simulium meridionale, Stomoxys spp., Tabanus spp., Tetanops spp., Tipula spp., for example Tipula paludosa, Tipula simplex and Toxotrypana curvicauda.

Hymenopteran species include Acromyrmex spp., Athalia spp., for example Athalia rosae, Atta spp., Camponotus spp., Dolichovespula spp., Diprion spp., for example Diprion similis, Hoplocampa spp., for example Hoplocampa cookei, Hoplocampa testudinea, Lasius spp., Linepithema (Iridiomyrmex) humile, Monomorium pharaonis, Paratrechina spp., Paravespula spp., Plagiolepis spp., Sirex spp., for example Sirex noctilio, Solenopsis invicta, Tapinoma spp., Technomyrmex albipes, Urocerus spp., Vespa spp., for example Vespa crabro, Wasmannia auropunctata and Xeris spp.

Preferred target pests include Tobacco moth also known as Warehouse moth (Ephestia elutella), Mediterranean Flour moth (Ephestia Kuehniella) (also known as “Indian Flour moth” and “Mill moth”), Raisin moth (Cadra figulilella), Almond Moth (Cadra cautella) and Indian Meal moth (Plodia interpunctella). Other insect pests that infest growing crops which may be targeted using the composition according to the invention include the larvae of corn earworm also known as the tomato fruitworm or tobacco budworm (Helicoverpa zea), cotton bollworm, podborer (Helicoverpa armigera), beet armyworm (Spodoptera exigua), tomato leafminer (Tuta absoluta), Egyptian cotton leafworm (Spodoptera littoralis), African armyworm (Spodoptera exempta), velvetbean caterpillar (Anticarsia gemmatalis), gypsy moth (Lymantria dispar), codling moth (Cydia pomonella), diamond back moth (Plutella xylostella), false codling moth (Thaumatotibia leucotreta), potato tuber moth (Phthorimaea operculella), summer fruit tortrix moth (Adoxphyes orana), oriental tea tortrix moth (Homona magnanima), and smaller tea tortrix moth, (Adoxophyes honmai). The above species may be targeted in all their host crops or parts thereof.

Preferably, the agricultural composition according to the invention is effective against at least one insect selected from Tuta absoluta, Spodoptera frugiperda, Spodoptera exigua Plutella xylostella and Helicoverpa armigera. Most preferably, the composition is effective against Tuta absoluta.

The agricultural compositions according to the invention may further comprise at least one auxiliary selected from carriers, ultraviolet protectants, diluents, coating polymers, surfactants and pH regulators in order to provide suitable formulations for use in agriculture, e.g., for improving its stability and/or increasing its shelf life during storage.

The agricultural composition of the invention may be provided to the end user in “ready-for-use” use form, i.e., the composition may be directly applied to the plants or seeds by a suitable device, such as a spraying or dusting device. Alternatively, the composition may be provided to the end user in the form of concentrates which have to be diluted, preferably with water, prior to use.

The formulation of the invention can be prepared in conventional manners, for example by mixing the compound of the invention with one or more suitable auxiliaries, such as disclosed herein.

For the purposes of the present invention, a carrier can be defined as a substance or mixture of substances (e.g., solvents, solutions, emulsions and suspensions) capable of holding the composition according to the invention without affecting its ability to perform its desired function. In other words, a carrier is a solid or liquid, natural or synthetic, organic or inorganic substance that is generally inert. The carrier generally improves the application of a composition, for instance, to plants, plants parts or seeds. Examples of suitable solid carriers include, but are not limited to, ammonium salts, in particular ammonium sulfates, ammonium phosphates and ammonium nitrates, natural rock flours, such as kaolins, clays, talc, chalk, quartz, attapulgite, montmorillonite and diatomaceous earth, silica gel and synthetic rock flours, such as finely divided silica, alumina and silicates. Examples of typically useful solid carriers for preparing granules include but are not limited to crushed and fractionated natural rocks such as calcite, marble, pumice, sepiolite and dolomite, synthetic granules of inorganic and organic flours and granules of organic material such as paper, sawdust, coconut shells, maize cobs and tobacco stalks. Examples of suitable liquid carriers include, but are not limited to, water, organic solvents and combinations thereof. Examples of suitable solvents include polar and nonpolar organic chemical liquids, for example from the classes of aromatic and nonaromatic hydrocarbons (such as cyclohexane, paraffins, alkylbenzenes, xylene, toluene, tetrahydronaphthalene, alkylnaphthalenes, chlorinated aromatics or chlorinated aliphatic hydrocarbons such as chlorobenzenes, chloroethylenes or methylene chloride), alcohols and polyols (which may optionally also be substituted, etherified and/or esterified, such as ethanol, propanol, butanol, benzylalcohol, cyclohexanol or glycol), ketones (such as acetone, methyl ethyl ketone, methyl isobutyl ketone, acetophenone, or cyclohexanone), esters (including fats and oils) and (poly)ethers, unsubstituted and substituted amines, amides (such as dimethylformamide or fatty acid amides) and esters thereof, lactams (such as N-alkylpyrrolidones, in particular N-methylpyrrolidone) and lactones, sulfones and sulfoxides (such as dimethyl sulfoxide), oils of vegetable or animal origin, nitriles (alkyl nitriles such as acetonitrile, propionotrilie, butyronitrile, or aromatic nitriles, such as benzonitrile), carbonic acid esters (cyclic carbonic acid esters, such as ethylene carbonate, propylene carbonate, butylene carbonate, or dialkyl carbonic acid esters, such as dimethyl carbonate, diethyl carbonate, dipropyl carbonate, dibutyl carbonate, dioctyl carbonate). The carrier may also be a liquefied gaseous extender, i.e., liquid which is gaseous at standard temperature and under standard pressure, for example aerosol propellants such as halohydrocarbons, butane, propane, nitrogen and carbon dioxide.

The amount of carrier typically ranges from 1% to 99.99%, preferably from 5% to 99.9%, more preferably from 10% to 99.5%, and most preferably from 20% to 99% by weight of the composition.

Liquid carriers are typically present in a range of from 20% to 90%, for example 30% to 80% by weight of the composition.

Solid carriers are typically present in a range of from 0% to 50%, preferably 5% to 45%, for example 10% to 30% by weight of the composition.

Suitable ultraviolet protectants may be selected from the group consisting of pigments, such as iron oxides, titanium dioxide, zinc dioxide; colorings, such as lycopene, betaine, bixin, curcumin, chlorophyll, tartrazine, saffron, carminic acid, other food colorings and optical brighteners, such as stilbene derivatives.

Suitable diluents may be selected from the group consisting of clays, such as kaolin, bentonites, sepiolites, starches, cellulose derivatives and Stearates, such as magnesium stearate.

Coating polymers may be selected from the group consisting of natural polymers, such as lignin, cellulose, starch, carrageenan, alginate, gum arabic, Xanthan gum, dextrans, synthetic polymers, such as acrylic derivatives (polymethyl acrylates) and polyesters.

pH regulators may be selected from the group consisting of buffers, such as phosphate, citrate, carbonate, borate phthalate buffer and combinations thereof.

Surfactants may be selected from the group consisting of anionic surfactants, such as carboxylate esters and polyethoxylated carboxylate derivatives; cationic surfactants, such as benzalkonium chloride and cetylpyridinium chloride; nonionic surfactants, such as polysorbates (Tween 20-80), sorbitan esters (Span 20-80) and octyl phenol ethoxylate (Triton); and amphoteric surfactants, such as betaines and sultaines.

The amount of surfactants typically ranges from 5% to 40%, for example 10% to 20%, by weight of the composition.

The composition according to the invention can be in solid form as powders, granules, tablets or pellets, in liquid form as suspensions, emulsifiable concentrates or emulsions, and can be applied to foliage, to soil, by dusting, by irrigation and/or by spraying, and can be mixed with compost, fertilizers, other bio-additives, vegetable extracts and agrochemicals. Additionally, the compositions can optionally contain biological or chemical enhancers of insecticidal activity.

Several formulations have been described as suitable for insect pathogenic viruses, e.g., in U.S. Patent Application Publication No. 2017/0172154 or PCT International Publication No. WO 2017/017234.

In another aspect, the present invention relates to a method for protecting a plant from insect pests comprising applying to such insect pest or its habitat or plant an insecticidally effective amount of the agricultural composition according to the invention.

In yet another aspect, the present invention relates to a method for reducing feeding damage on plants caused by insect pests comprising applying to such insect pests or their habitat or plant an insecticidally effective amount of the agricultural composition according to the invention.

The compositions according to the invention may be applied to any plant or plant part. Plant parts should be understood to mean all parts and organs of the plants above and below ground, such as shoot, leaf, flower and root, examples given being leaves, needles, stalks, stems, flowers, fruit bodies, fruits and seeds, and also tubers, roots and rhizomes. Parts of plants also include harvested plants or harvested plant parts and vegetative and generative propagation material, for example seedlings, tubers, rhizomes, cuttings and seeds. Alternatively, or in addition, the composition of the invention may be applied to insect pests, including adults and larvae of all stages as well as eggs.

Basically, any plant, prior or during infestation, may be treated with the composition according to the invention. Most common crop plants include cereals (for example rice, barley, wheat, rye, oats, maize and the like), beans (soya bean, aduki bean, bean, broadbean, peas, peanuts and the like), fruit trees/fruits (apples, citrus species, pears, grapevines, peaches, Japanese apricots, cherries, walnuts, almonds, bananas, strawberries and the like), vegetable species (cabbage, tomato, spinach, broccoli, lettuce, onions, spring onion, pepper and the like), root crops (carrot, potato, sweet potato, radish, lotus root, turnip and the like), plants for industrial raw materials (cotton, hemp, paper mulberry, mitsumata, rape, beet, hops, sugar cane, sugar beet, olive, rubber, palm trees, coffee, tobacco, tea and the like), cucurbits (pumpkin, cucumber, water melon, melon and the like), meadow plants (cocksfoot, sorghum, timothy-grass, clover, alfalfa and the like), lawn grasses (mascarene grass, bentgrass and the like), spice plants etc. (lavender, rosemary, thyme, parsley, pepper, ginger and the like) and flowers (chrysanthemums, rose, orchid and the like).

Generally, between 1×10⁸ and 1×10¹⁵ occlusion bodies/ha of one virus, preferably between 1×10¹⁰ and 5×10¹⁴ occlusion bodies, especially preferably between 5×10¹¹ and 1×10¹⁴ occlusion bodies, in particular between about 1×10¹² and 5×10¹³ occlusion bodies/ha are applied.

Depending on the level of infestation, one or more applications may be necessary. For example, up to three applications are made at an interval of between one and three weeks, in particular at an interval of two weeks.

In another aspect, the present invention relates to the use of the agricultural composition according to the invention for protecting a plant from insect pests.

Use of the agricultural composition according to any one of claims 1 to 14 for reducing feeding damage on plants caused by insects.

Most preferably, for all embodiments of the present invention said insect pest is selected from the group consisting of Tuta absoluta, Spodoptera frugiperda, Spodoptera exigua, Plutella xylostella and Helicoverpa armigera, in particular Tuta absoluta.

The present invention also relates to a method for producing an agricultural composition according to the invention, comprising mixing said insect pathogenic viruses and optionally at least one auxiliary.

### EXAMPLES

The examples illustrate the present invention in a non-limiting fashion.

### Example 1: Material and Methods

### Insects and Viruses:

The laboratory colonies of Spodoptera frugiperda, Spodoptera exigua and Helicoverpa armigera were reared on standard noctuid artificial diet, Tuta absoluta were reared on tomato plants under controlled conditions 25±1° C. and a 55±5% relative humidity. The origin of the populations is described in Table 1.

Other insects used in the bioassay were purchased from Benzon.

Five different baculovirus formulations comprising Autographica californica multiple nucleopolyhedrovirus (AcMNPV), Helicoverpa armigera nucleopolyhedrosis virus (HaNPV), Plutella xylostella granulovirus (PxGV), Spodoptera litura nucleopolyhedrovirus (SpltNPV) and Spodoptera exigua nucleopolyhedrovirus (SeNPV) were tested against the above-mentioned lepidopteran species. The application rate was: 6.67×106/mL for AcMNPV, 1.20×107/mL for HaNPV, 6.00×106/mL for SeNPV, 1.33×107 for SpltNPV and 1.00×108 for PxGV in 450 L water/ha (see Table 2). The mix of viruses contained all five viruses with mentioned concentrations in 450 L water/ha (6.67×106 AcMNPV+1.20×107 HaNPV+6.00×106 SeNPV+1.33×107 SpltNPV+1.00×108 PxGV in 450 L water/ha). The final application rate per ha is described in Table 2. Commercial product based on Bt-toxins (4 mL/L) served as a positive control.

Experiments were conducted at RT using maize (Zea mays subsp. mays) for Spodoptera frugiperda and Spodoptera exigua, cotton (Gossypium herbaceum) for Helicoverpa armigera and tomato (Solanumlycopersicum) for Tuta absoluta.

### Insect Bioassays:

Twelve second- to third-instar larvae of S. frugiperda, S. exigua, T. ni; P. xylostella; H. zea; H. virescens; or H. armigera were prepared for each treatment. Leaf discs of cotton, corn and cabbage as well as S. frugiperda, S. exigua and H. armigera larvae were dipped for two seconds in the prepared solutions and placed in 12-well plates. To avoid leaf disc desiccation either wet filter papers or 1% agar were placed under the leaf disc in the plates. In Examples 2 to 4, larval survival and feeding damage (% severity of damage) was observed on day four and day seven post treatment. Larvae were considered as dead when completely immobile. Affected larvae were considered as alive. In examples 5 to 7, the leaf damage was recorded after seven days post treatment. Abbott was calculated as below formula:

$$Abbott of leaf consumption \% = ( 1 - \frac{n in T after Treatment}{n in Co after Treatment} ) * 100$$

n: % of leaf consumption; T: treatment, Co: Control without treatment

For Tuta absoluta five tomato leaves infected with first- to second-instar larvae were used in the bioassays. For T. absoluta whole tomato leaves infected with the insects were dipped in the different virus solutions and incubated in petri dishes.

TABLE 1a
The origin of lepidopteran species used
in the bioassay (Examples 2 to 4).

| Species | Country | City | Crop Season |
|---|---|---|---|
| Spodoptera | Brazil | São Paulo | 2005 |
| frugiperda | | | |
| Spodoptera exigua | England | ICI | 1989 |
| Helicoverpa armigera | Germany | Darmstadt | 2000 |
| Tuta absoluta | Brazil | Paulinia | 2008 |

TABLE 1b
The origin of lepidopteran species used
in the bioassay (Examples 5 to 7).

| Species | Source Country |
|---|---|
| Spodoptera frugiperda | Brazil |
| Spodoptera exigua | England |
| Helivoverpa amigera | Germany |
| Tuta absoluta | Brazil |
| Trichoplusia ni | United States |
| Plutella xylostella | United States |
| Heliothis virescens | United States |
| Helicoverpa zea | United States |
| Spodoptera exigua | United States |

### Examples 2 to 4

| | | | | Final | Final |
|---|---|---|---|---|---|
| | Original | Original | mL or g per | Application | Application |
| Baculoviruses | Formulation | PIB/mL or g | 450 L/ha | Rate/mL | Rate/ha |
| AcMNPV | liquid | 7.50 × 10⁹ | 400 | 6.67 × 10⁶ | 3.00 × 10¹² |
| HaNPV | WG | 6.00 × 10¹⁰ | 90 | 1.20 × 10⁷ | 5.40 × 10¹² |
| PxGV | liquid | 3.00 × 10¹⁰ | 1500 | 1.00 × 10⁸ | 4.50 × 10¹³ |
| SpltNPV | WG | 2.00 × 10¹⁰ | 300 | 1.33 × 10⁷ | 6.00 × 10¹² |
| SeNPV | WG | 3.00 × 10¹⁰ | 90 | 6.00 × 10⁶ | 2.70 × 10¹² |
| Combination | | | | 6.67 × 10⁶ | 3.00 × 10¹² |
| of all 5 | | | | 1.20 × 10⁷ | 5.40 × 10¹² |
| viruses: | | | | 1.00 × 10⁸ | 4.50 × 10¹³ |
| 1:1:1:1 | | | | 1.33 × 10⁷ | 6.00 × 10¹² |
| | | | | 6.00 × 10⁶ | 2.70 × 10¹² |

### Examples 5 to 7

| | Original | Original Polyhedral | Final Application |
|---|---|---|---|
| | Formulation | Inclusion Bodies (PIB) | Rate/mL |
| AcMNPV | WG | 3.2 × 10¹⁰/g | 1 × 10⁸ |
| HaNPV | WG | 6 × 10¹⁰/g | 1 × 10⁸ |
| PxGV | liquid | 3 × 10¹⁰/ml | 1 × 10⁸ |
| SpltNPV | WG | 2 × 10¹⁰/g | 1 × 10⁸ |
| SeNPV | WG | 3 × 10¹⁰/g | 1 × 10⁸ |
| AcMNPV | | | 1 × 10⁸ |
| HaNPV | | | 1 × 10⁸ |
| PxGV | | | 1 × 10⁸ |
| SpltNPV | | | 1 × 10⁸ |
| SeNPV | | | 1 × 10⁸ |

### Example 8

| Baculoviruses | | Original | Rate g | Field |
|---|---|---|---|---|
| Combination | Original | PIB/mL | or | Application |
| of 5 viruses | Formulation | or g | ml/ha | Rate/ha |
| AcMNPV | liquid | 7.50 × 10⁹ | 200 | 1.5 × 10¹² |
| HaNPV | WG | 6.00 × 10¹⁰ | 90 | 5.4 × 10¹² |
| PxGV | liquid | 3.00 × 10¹⁰ | 1500 | 4.5 × 10¹³ |
| SpltNPV | WG | 2.00 × 10¹⁰ | 300 | 6.0 × 10¹² |
| SeNPV | WG | 3.00 × 10¹⁰ | 90 | 2.7 × 10¹² |
| HaNPV | WG | 6.00 × 10¹⁰ | 90 | 5.4 × 10¹² |
| PxGV | liquid | 3.00 × 10¹⁰ | 1500 | 4.5 × 10¹³ |
| SeNPV | WG | 3.00 × 10¹⁰ | 90 | 2.7 × 10¹² |

### Example 2: A Combination of Five Baculoviruses Exert Excellent Activity Against Tuta absoluta

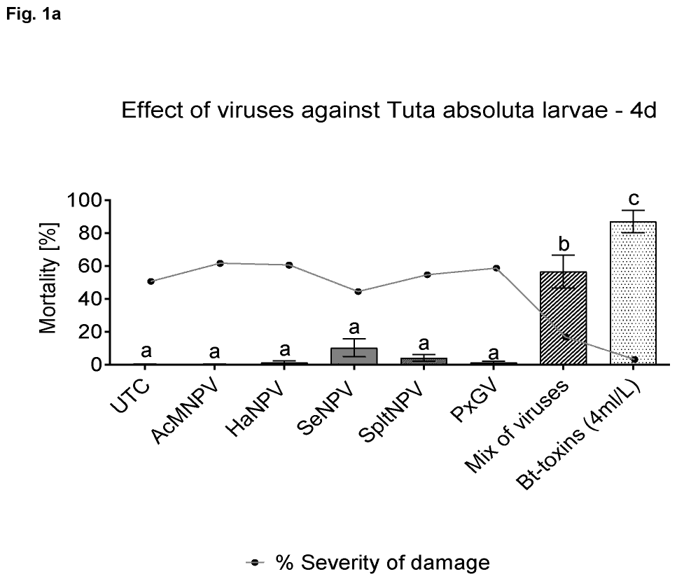

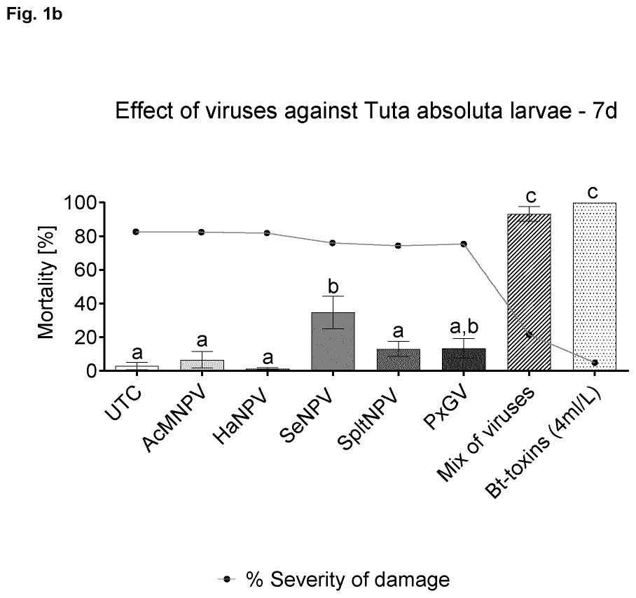

The experimental setup is described in Example 1. The five single viruses AcMNPV, HaNPV, PxGV, SpltNPV and SeNPV were tested as well as a mixture of all five viruses. 10 leaves per treatment were used. As can be seen in FIG. 1, the mixture of five viruses exert an unexpected efficacy against Tuta absoluta already 4 days after treatment which was not derivable from the activity of any of the single viruses.

### Example 3: A Combination of Five Baculoviruses Exert Excellent Activity Against Spodoptera frugiperda

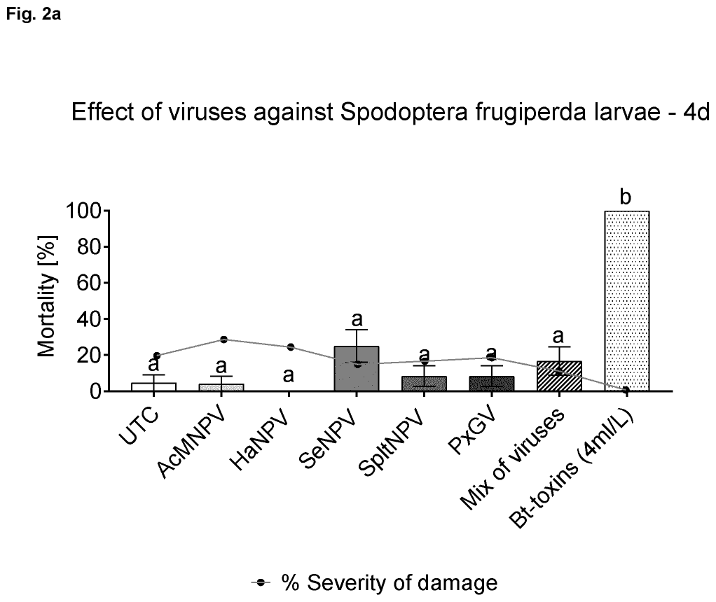

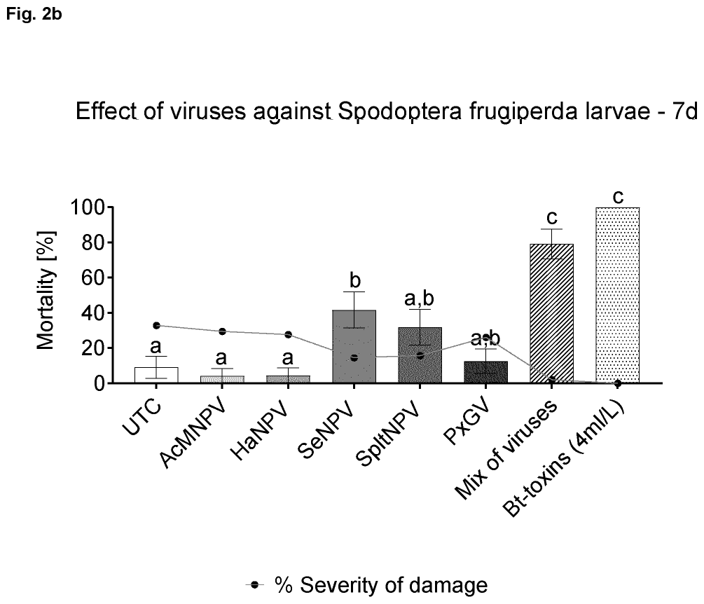

The experimental setup is described in Example 1. The five single viruses AcMNPV, HaNPV, PxGV, SpltNPV and SeNPV were tested as well as a mixture of all five viruses. 24 larvae per treatment were used. As can be seen in FIG. 2, the mixture of five viruses, at least 7 days after treatment, exert an unexpected efficacy against Spodoptera frugiperda which was not derivable from the activity of any of the single viruses.

### Example 4: A Combination of Five Baculoviruses Exert Excellent Immediate Activity Against Helicoverpa armigera and Spodoptera exigua

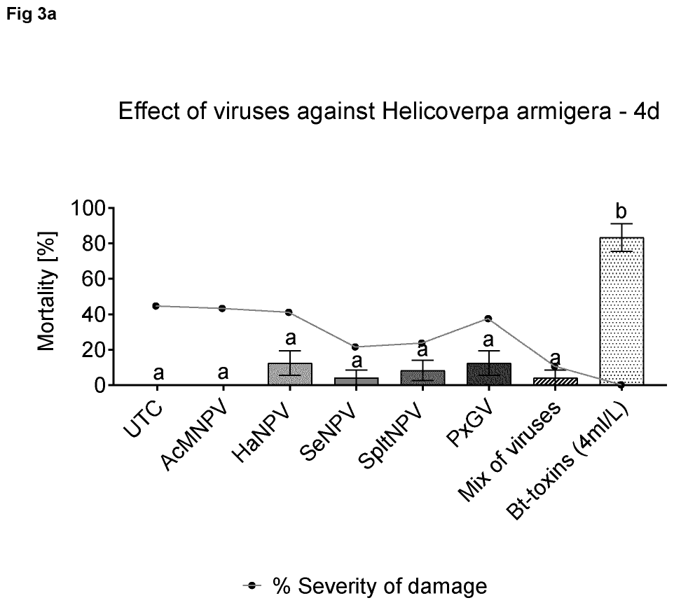

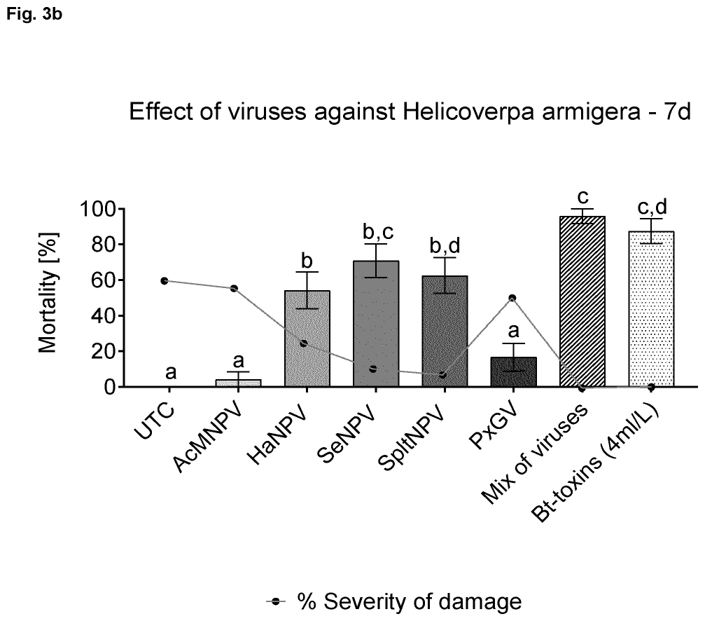

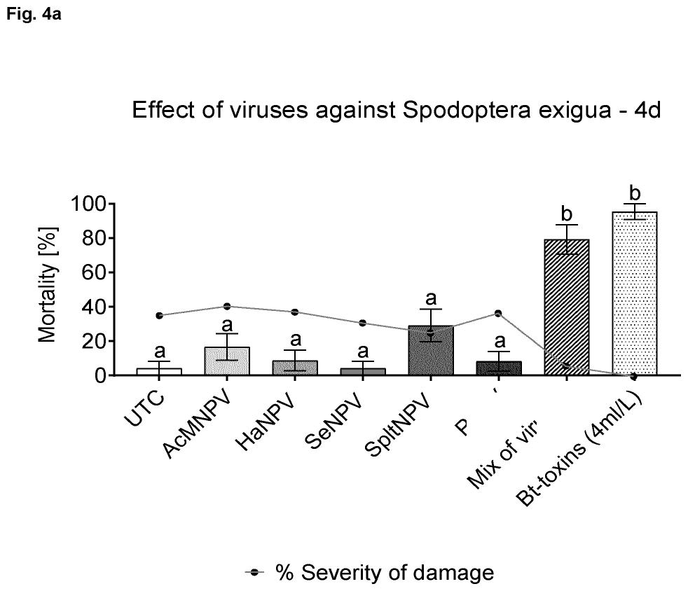

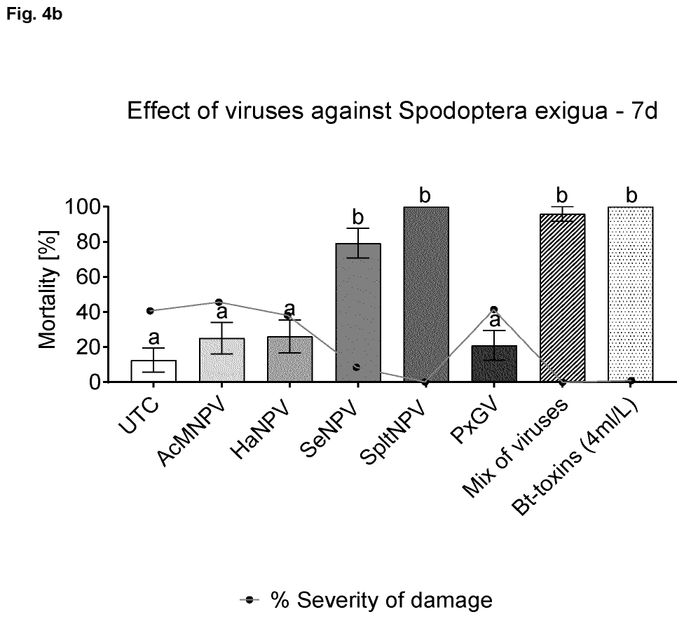

The experimental setup is described in Example 1. The five single viruses AcMNPV, HaNPV, PxGV, SpltNPV and SeNPV were tested as well as a mixture of all five viruses. 24 larvae per treatment were used. As can be seen in FIGS. 3 and 4, the mixture of five viruses exert an unexpected efficacy against Helicoverpa armigera and Spodoptera exigua 4 days after treatment which was not derivable from the activity of any of the single viruses. Most notably, the damage effected to the plants is very low.

### Example 5: A Combination of Five Baculoviruses Exert Excellent Immediate Activity Against Helicoverpa armigera and Spodoptera exigua

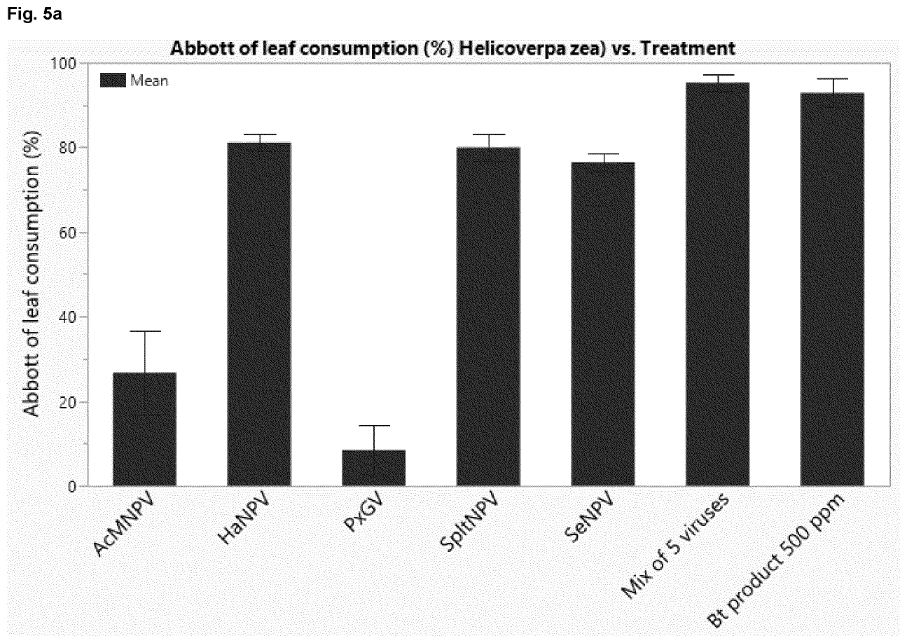

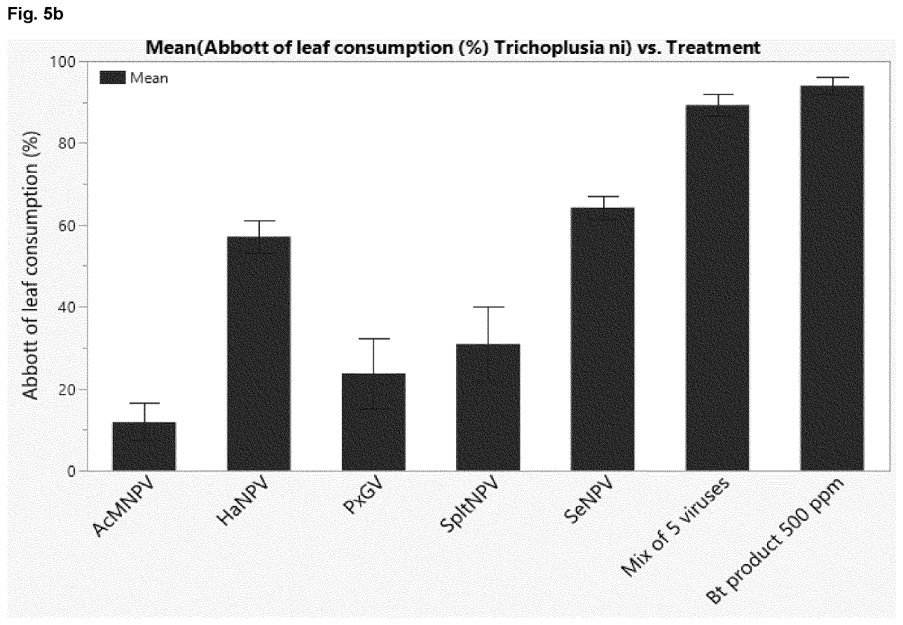

The experimental setup is described in Example 1. The five single viruses AcMNPV, HaNPV, PxGV, SpltNPV and SeNPV were tested as well as a mixture of all five viruses. 24 larvae per treatment were used. As can be seen in FIG. 5, the mixture of five viruses exert an unexpected efficacy against Helicoverpa zea and Trichoplusia ni 7 days after treatment which was not derivable from the activity of any of the single viruses.

### Example 6: A Combination of Three Baculoviruses Exert Excellent Activity Against Spodoptera exigua

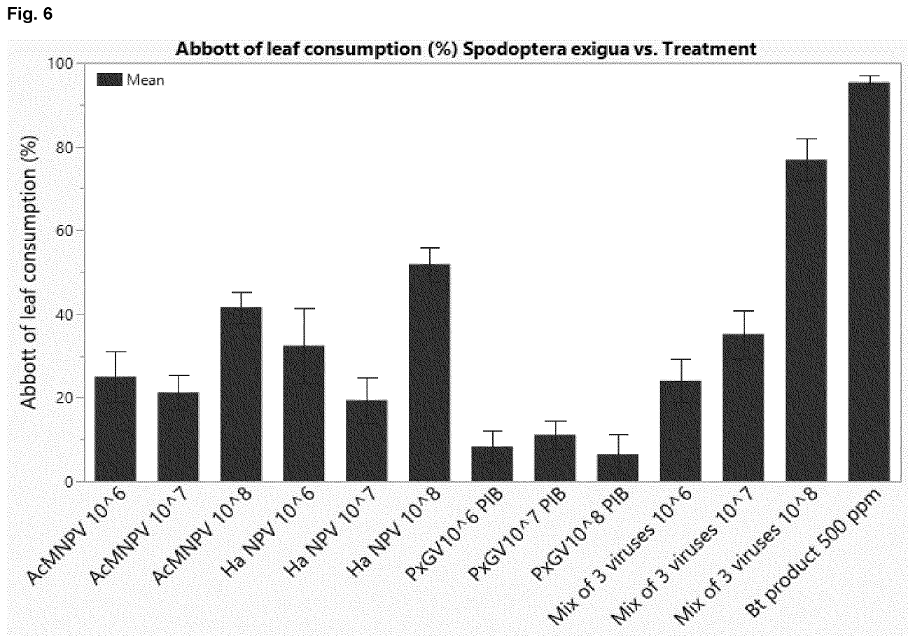

The experimental setup is described in Example 1. The three single viruses AcMNPV, HaNPV, PxGV, were tested as well as a mixture of all three viruses. 12 larvae per treatment were used. As can be seen in FIG. 6, the mixture of three viruses exert an unexpected efficacy against Spodoptera exigua 7 days after treatment which was not derivable from the activity of any of the single viruses. The 3 viruses combination showed very good dose response.

### Example 7: A Combination of 4 Baculoviruses Shows Broad Spectrum Against Lepidoptera Species

The experimental setup is described in Example 1. The different combinations tested are listed below:

Mix 1234 (AcMNPV, HaNPV, PxGV and SpltNPV)

Mix 1245 (AcMNPV, HaNPV, SpltNPV and SeNPV

Mix 2345 (HaNPV, PxGV, SpltNPV and SeNPV)

Mix 5 (AcMNPV, HaNPV, PxGV, SltNPV and SeNPV)

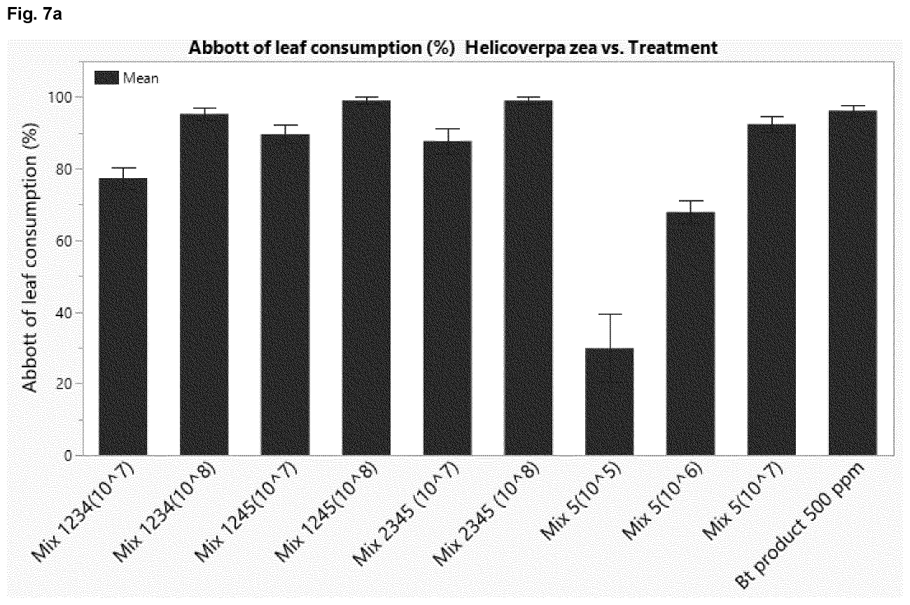

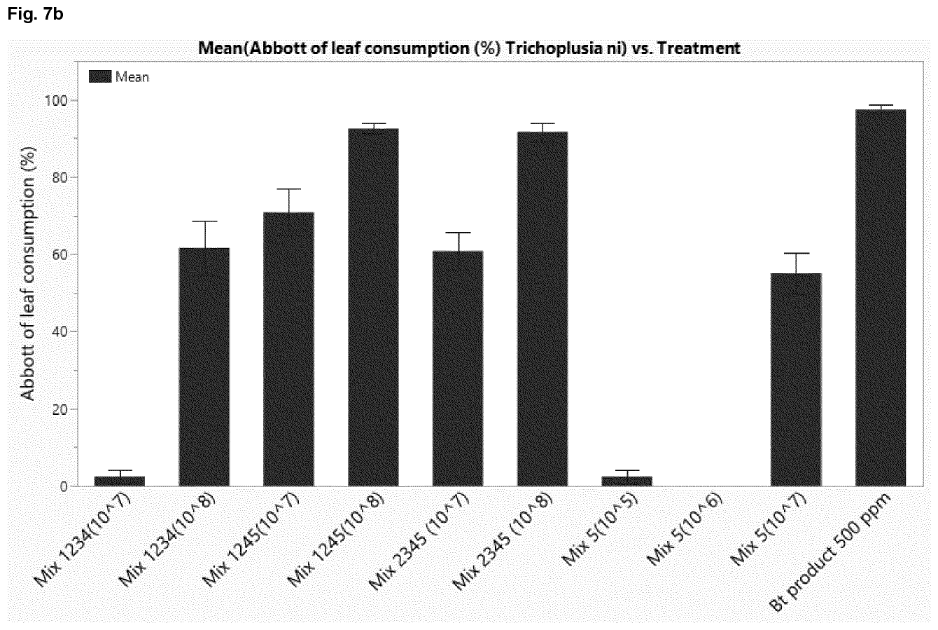

The combinations comprising four baculoviruses were tested at 107 and 108 PIB and five combination at 105, 106 and 107 against Spodoptera frugiperda, Trichoplusia ni and Helicoverpa zea. 12 larvae per treatment were used. Based on FIG. 7, it can be seen that all combinations have better efficacy than the single viruses (see above).

### Example 8: Materials and Methods for Field Testing Baculoviruses Combinations

Complete Randomized block experiments were set up at sites in Italy and Spain in 2020. The five virus combination of AcMNPV, HaNPV, PxGV, SpltNPV and SeNPV were tested at 3 rates 100%, 50% and 10% of Field application rate (Table above). In addition a three virus combination HaNPV, PxGV and SeNPV were tested at 100%, 50% and 10% of Field application rate (Table above) Spray applications were made at 400-1200 L/ha water volume and repeated at 7-10 day intervals (applications A, B, C, D). Pest control, % incidence and severity of crop damage caused by the target pest were assessed 3, 7, 10, 14 days after the last application (DAA, DAB, DAC or DAD).

### Example 9: A Combination of Five Baculoviruses Exert Excellent Activity Against Tuta absoluta

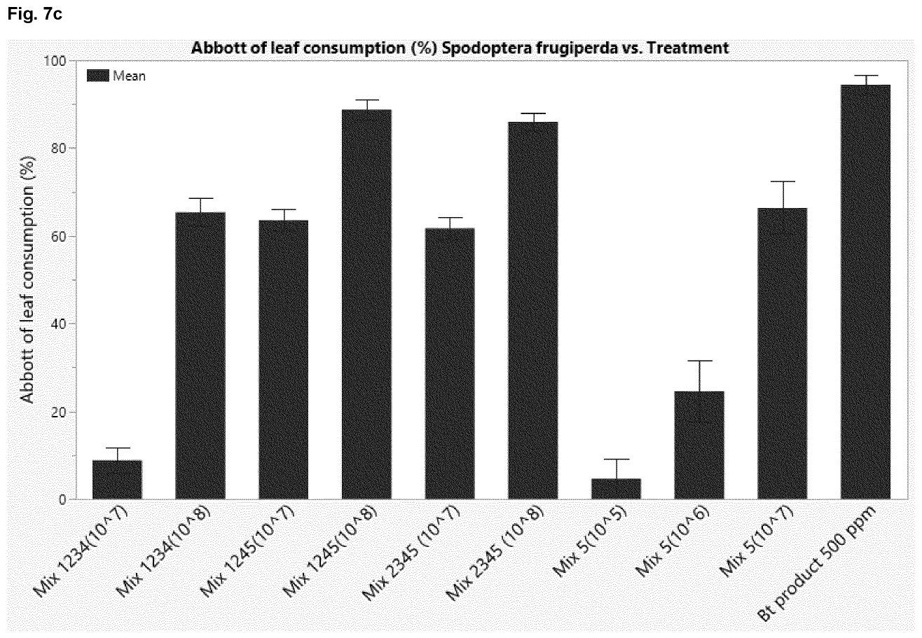

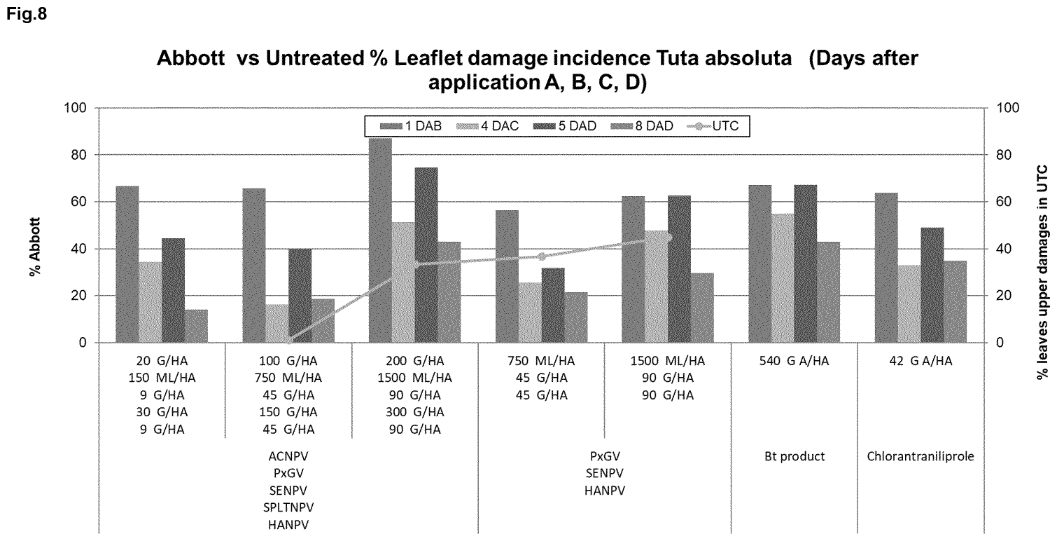

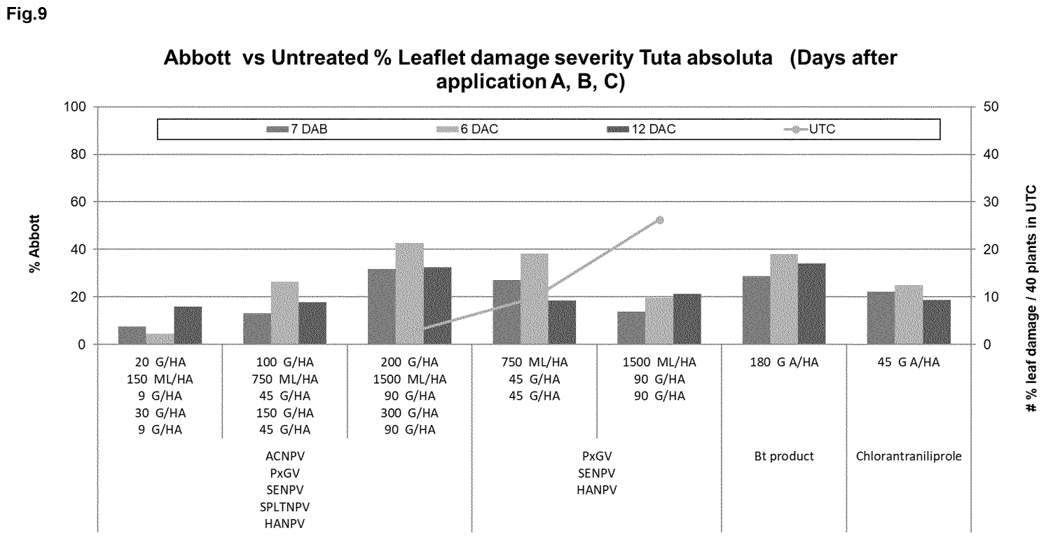

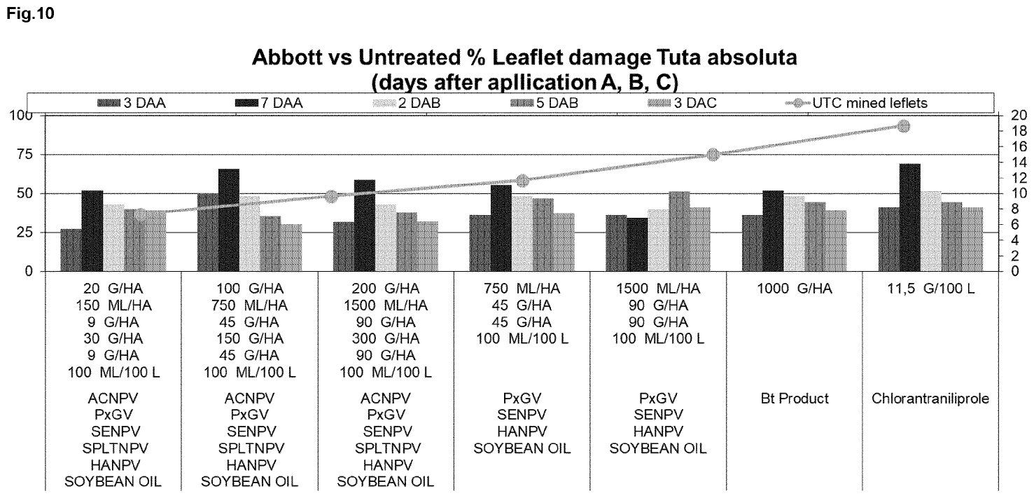

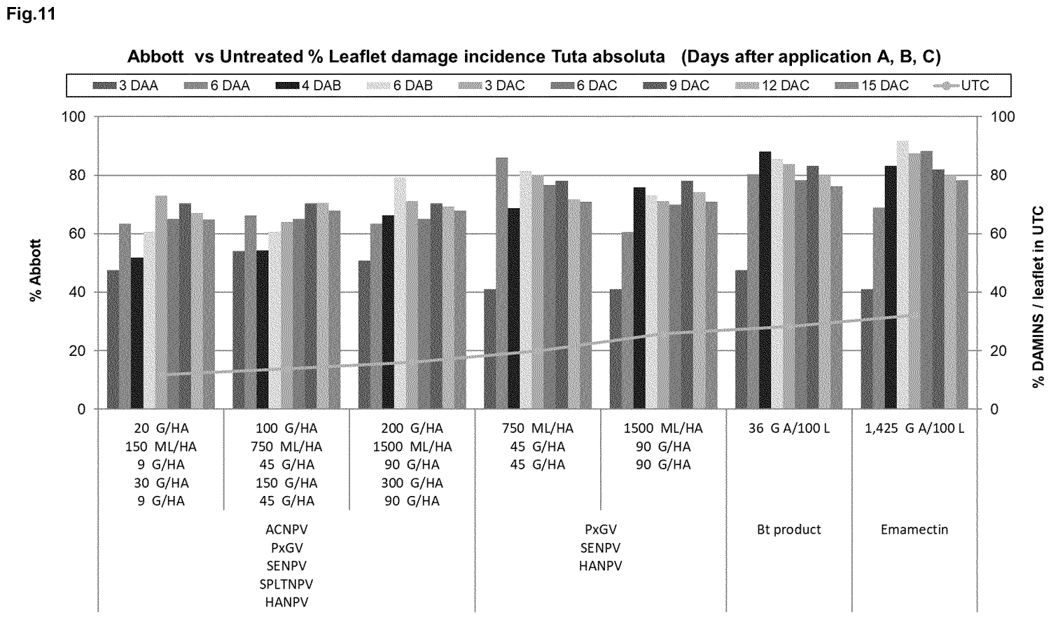

As can be seen in FIGS. 8 to 11 the mixture of five viruses exert a high level of efficacy against Tuta absoluta from 3-15 days after application, similar to reference products

### Example 10: A Combination of Three Baculoviruses Exert Activity Against Tuta absoluta

As can be seen in FIGS. 8 to 11 the mixture of five viruses exert a high level of efficacy against Tuta absoluta from 3-15 days after application, similar to reference products

### Example 11: A Combination of Five Baculoviruses Exert Excellent Activity Against Spodoptera exigua

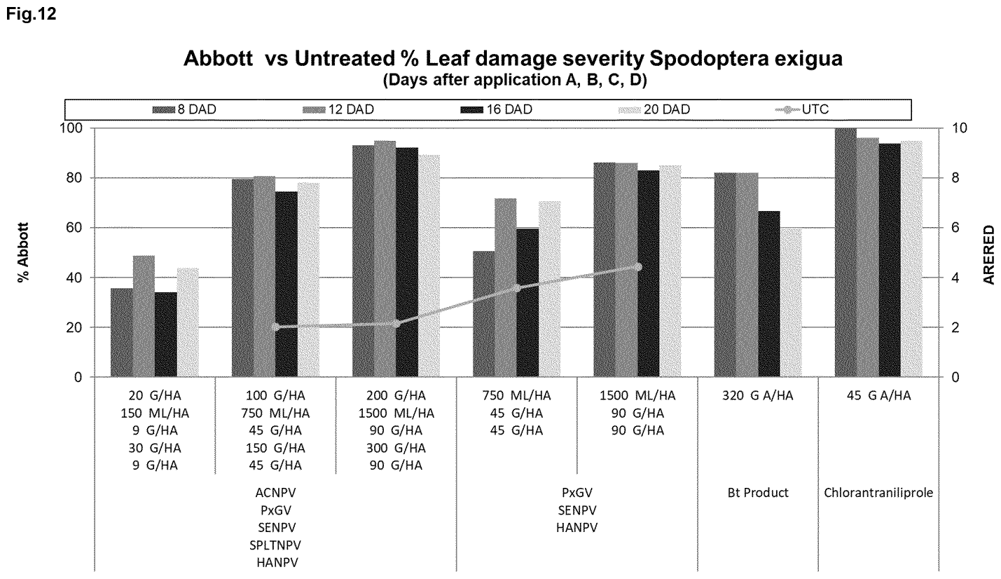

As can be seen in FIG. 12, the mixture of five viruses exert a high level of efficacy against Spodoptera exigua from 8-20 days after application, better than the 3 virus combination and similar to Bt reference product.

### Example 12: A Combination of Five Baculoviruses Exert Excellent Activity Against Helicoverpa armigera

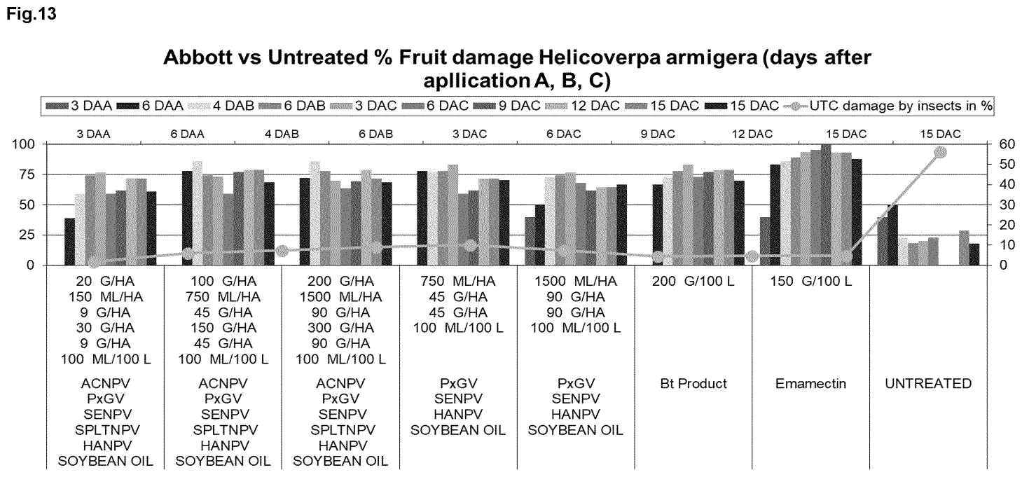

As can be seen in FIG. 13, the mixture of five viruses exert a high level of efficacy against Helicoverpa armigera from 3-15 days after application, better than the 3 virus combination and similar to Bt reference product.

### Example 13: A Combination of Five Baculoviruses Exert Activity Against Plutella xylostella

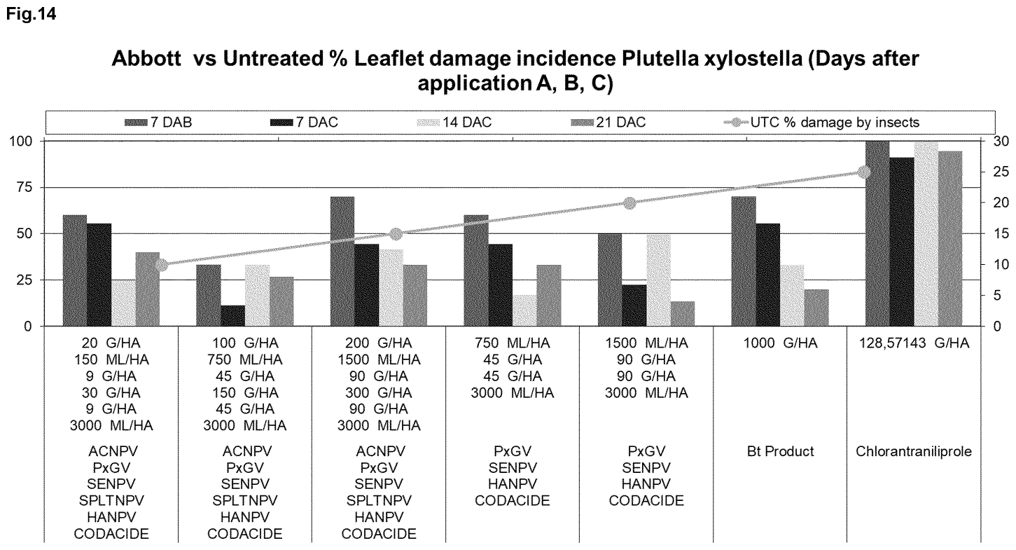

As can be seen in FIG. 14, the mixture of five viruses exert a moderate level of efficacy against Plutella xylostella from 7-21 days after application, better than the 3 virus combination and similar to Bt reference product.

1. An agricultural composition comprising at least three insect pathogenic viruses, selected from Autographica californica (Alfalfa Looper) multiple nucleopolyhedrovirus (AcMNPV), Helicoverpa armigera nucleopolyhedrosis virus (HaNPV), Plutella xylostella granulovirus (PxGV), Spodoptera litura (oriental leafworm moth) nucleopolyhedrovirus (SpltNPV) and Spodoptera exigua (beet armyworm) nucleopolyhedrovirus (SeNPV).

2. The agricultural composition according to claim 1 wherein said at least three insect pathogenic viruses are AcMNPV, HaNPV and PxGV.

3. The agricultural composition according to claim 1 wherein said at least three insect pathogenic viruses are SeNPV, HaNPV and PxGV.

4. The agricultural composition according to claim 1, comprising the insect pathogenic viruses in a ratio of between 5:1:1 and 1:1:5.

5. The agricultural composition according to claim 2, wherein the ratio of the insect pathogenic viruses is 1:1:1.

6. The agricultural composition according to claim 1, comprising at least one further insect pathogenic virus.

7. The agricultural composition according to claim 2, comprising at least one further insect pathogenic virus selected from the group consisting of Spodoptera litura (oriental leafworm moth) nucleopolyhedrovirus (SpltNPV) and Spodoptera exigua (beet armyworm) nucleopolyhedrovirus (SeNPV).

8. The agricultural composition according to claim 1, comprising AcMNPV, HaNPV, PxGV and SpltNPV.

9. The agricultural composition according to claim 1, comprising AcMNPV, HaNPV, PxGV and SeNPV.

10. The agricultural composition according to claim 1 comprising AcMNPV, HaNPV, PxGV, SpltNPV and SeNPV.

11. The agricultural composition according to claim 1 wherein each insect pathogenic virus is present in an amount of between 1×10⁸ and 1×10¹² occlusion bodies per mL or per gram.

12. The agricultural composition according to claim 1, wherein said insect pathogenic viruses are selected from AcMNPV isolates comprised in VPN-ULTRA from Agricola El Sol, LOOPEX from Andermatt Biocontrol, LEPIGEN from AgBiTech and isolate C6, HaNPV isolates comprises in VIVUS® MAX and ARMIGEN from AgBiTech, HELICOVEX from Andermatt Biocontrol and Keyun HaNPV, PxGV isolates comprised in PLUTELLAVEX® from Keyun, and isolate K1, SpltNPV isolate K1 and SeNPV isolates comprised in KEYUN SeNPV.

13. The agricultural composition according to claim 1, wherein at least one insect pathogenic virus is a recombinant virus.

14. The agricultural composition according to claim 1, which is effective against at least one insect selected from Tuta absoluta, Spodoptera frugiperda, Spodoptera exigua and Helicoverpa armigera.

15. The agricultural composition according to claim 1, further comprising at least one auxiliary selected from carriers, ultraviolet protectants, frost protectants, diluents, coating polymers, surfactants and pH regulators.

16. A method for protecting a plant from insect pests comprising applying to such insect pest or its habitat or plant an insecticidally effective amount of the agricultural composition according to claim 1.

17. A method for reducing feeding damage on plants caused by insect pests comprising applying to such insects or insect habitat or plant an insecticidally effective amount of the agricultural composition according to claim 1.

18. The method of claim 16, wherein said insect pest is selected from Tuta absoluta, Spodoptera frugiperda, Spodoptera exigua, Plutella xylostella and Helicoverpa armigera.

19-22. (canceled)

23. The method for producing an agricultural composition according to claim 1, comprising mixing said insect pathogenic viruses and optionally at least one auxiliary.
